(19) United States
(12) Patent Application Publication
(10) Pub. No.: US 2004/0160216 A1
(43) Pub. Date: Aug. 19, 2004

(54) METHOD AND SYSTEM FOR CONFIGURING POWER ELECTRONICS IN AN ELECTROCHEMICAL CELL SYSTEM

(75) Inventors: A. John Speranza, West Hartford, CT (US); Neil J. Barabas, Chatsworth, CA (US)

Correspondence Address: CANTOR COLBURN, LLP, 55 GRIFFIN ROAD SOUTH, BLOOMFIELD, CT, 06002

(73) Assignee: Proton Energy Systems, Inc., Wallingford, CT (US)

(21) Appl. No.: 10/708,051

(22) Filed: Feb. 5, 2004

Related U.S. Application Data
(60) Provisional application No. 60/319,927, filed on Feb. 6, 2003.

(51) Int. Cl. H02J 7/04

(52) U.S. Cl. 320/140

(57) ABSTRACT

Disclosed herein is a method and system for configuring power electronics in an electrochemical cell system. Exemplary embodiments include power electronics having a power converter for an electrochemical cell system. The power converter includes a plurality of interchangeable power converter modules and a motherboard configured to receive the plurality of interchangeable power converter modules. A power rating of the power converter is capable of being changed by adjusting a number of the interchangeable power converter modules attached to the mother-board.

### CROSS REFERENCE TO RELATED APPLICATIONS

This application claims the benefits of U.S. Provisional Patent Application Serial No. 60/319,927 filed Feb. 6, 2003, the entire contents of which are incorporated herein by reference.

### FEDERAL RESEARCH STATEMENT

This invention was made with Government support under contract DE-FC36-98GO10341 awarded by the Department of Energy. The Government has certain rights in this invention.

### BACKGROUND OF INVENTION

This disclosure relates generally to power electronics, and especially relates to power electronics associated with the storage and recovery of energy from electrochemical cells.

Electrochemical cells are energy conversion devices, usually classified as either electrolysis cells or fuel cells. An electrolysis cell typically generates hydrogen by the electrolytic decomposition of water to produce hydrogen and oxygen gases, whereas in a fuel cell, hydrogen typically reacts with oxygen to generate electricity. In a typical fuel cell, hydrogen gas and reactant water are introduced to a hydrogen electrode (anode), while oxygen gas is introduced to an oxygen electrode (cathode). The hydrogen gas for fuel cell operation can originate from a pure hydrogen source, methanol or other hydrogen source. Hydrogen gas electrochemically reacts at the anode to produce hydrogen ions (protons) and electrons, wherein the electrons flow from the anode through an electrically connected external load, and the protons migrate through a membrane to the cathode. At the cathode, the protons and electrons react with the oxygen gas to form resultant water, which additionally includes any reactant water dragged through the membrane to the cathode. The electrical potential across the anode and the cathode can be exploited to power an external load.

This same configuration is conventionally employed for electrolysis cells. In a typical anode feed water electrolysis cell, process water is fed into a cell on the side of the oxygen electrode (in an electrolytic cell, the anode) to form oxygen gas, electrons, and protons. The electrolytic reaction is facilitated by the positive terminal of a power source electrically connected to the anode and the negative terminal of the power source connected to a hydrogen electrode (in an electrolytic cell, the cathode). The oxygen gas and a portion of the process water exit the cell, while protons and water migrate across the proton exchange membrane to the cathode where hydrogen gas is formed. The hydrogen gas generated may then be stored for later use by an electrochemical cell.

Electrochemical cells can be employed to both convert electricity into hydrogen, and hydrogen back into electricity as needed. Electrochemical cell systems performing both functions are commonly referred to as regenerative fuel cell systems. Regenerative fuel cell systems may be used either as a primary power source or a secondary power source to supplement the primary power source. Where the regenerative fuel cell system is used as a secondary power source, an electrochemical cell operates to convert excess electrical energy from the primary power source and/or supplemental energy from another secondary power source (e.g., a solar collector, windmill, etc.) into chemical energy in the form of hydrogen, which can be stored for later use. When the primary source of power is unavailable, the electrochemical cell operates to convert the stored chemical energy into electrical energy.

The electrical energy input to and/or output from the electrochemical cell typically requires conditioning to ensure its compatibility with the electrical requirements of the load, primary power source, or other secondary power source associated with the electrochemical cell. The devices that perform such conditioning are known as “power electronics”. Power electronics may include, for example, alternating current (AC) to direct current (DC) converters (converters), DC to AC converters (inverters), and DC to DC converters.

Power electronics play a significant role in the overall electrochemical cell system efficiency. Traditionally, electrochemical cell power electronics efficiencies have been in the 85%-90% range. Power electronics also add significant monetary cost the electrochemical cell system. For example, rectifiers, which are commonly used for AC to DC conversion, represent about 10%-15% of the material cost of the electrochemical cell system. While it is desired to have power electronics that are both efficient and cost effective, these two goals are typically at odds. For example, high frequency switch mode converters are relatively efficient, but the cost of this technology does not readily lend itself to cost reduction. Thus, power electronics that are both efficient and cost effective are desired.

### SUMMARY OF INVENTION

Disclosed herein is a method and system for configuring power electronics in an electrochemical cell system. Exemplary embodiments of power electronics for an electrochemical cell system comprise: a first power converter including: a plurality of interchangeable power converter modules, and a first motherboard configured to receive the plurality of interchangeable power converter modules, wherein a power rating of the first power converter may be changed by adjusting a number of interchangeable power converter modules attached to the first motherboard. In one embodiment, a controller is configured to adjust a current output from interchangeable power converter modules attached to the first motherboard. In another embodiment, the power electronics further comprise a second power converter including: a second motherboard configured to receive at least a portion of the plurality of interchangeable power converter modules, wherein a power rating of the second power converter may be adjusted by changing a number of interchangeable power converter modules attached to the second motherboard. In another embodiment, the controller is further configured to adjust a current output from interchangeable power converter modules attached to the second motherboard.

Exemplary embodiments of an electrochemical cell system comprise a first power source, an electrochemical cell, and a modular power electronics system electrically connected between the first power source and the electrochemical cell. In an embodiment, the modular power electronics system includes: a first power converter for conditioning electrical current flowing between the first power source and the electrochemical cell. The first power converter includes: a plurality of interchangeable power converter modules, and a first motherboard configured to receive the plurality of interchangeable power converter modules, wherein a power rating of the first power converter may be adjusted by changing a number of interchangeable power converter modules attached to the first motherboard. In one embodiment, a controller is configured to adjust a current output from interchangeable power converter modules attached to the first motherboard. In another embodiment, the electrochemical cell system further comprises a second power source, and the modular power electronics system further includes a second power converter for conditioning electrical current flowing between the second power source and the electrochemical cell. The second power converter may include a second motherboard configured to receive at least a portion of the plurality of interchangeable power converter modules, wherein a power rating of the second power converter is adjustable by changing a number of interchangeable power converter modules attached to the second motherboard. In another embodiment, the controller is further configured to adjust a current output from interchangeable power converter modules attached to the second motherboard.

An exemplary method of configuring power electronics for an electrochemical cell system includes adjusting a power rating of a first power converter by changing a number of interchangeable power converter modules attached to a first motherboard. In one embodiment, the method further includes adjusting a current output from the interchangeable power converter modules attached to the first motherboard using a single controller. In another embodiment, the method further includes adding a second motherboard to a power converter box housing the first motherboard and the single controller, and adjusting a power rating of a second power converter by changing a number of interchangeable power converter modules attached to the second motherboard. In another embodiment, the method further includes adjusting current output from the interchangeable power converter modules attached to the second motherboard using the single controller.

The above discussed and other features will be appreciated and understood by those skilled in the art from the following detailed description and drawings.

### BRIEF DESCRIPTION OF DRAWINGS

Referring now to the drawings, which are meant to be exemplary and not limiting, and wherein like elements are numbered alike:

FIG. 1 is a block diagram of an electrochemical cell system including power electronics;

FIG. 2 is a block diagram of a modular power converter providing AC to DC conversion for the electrochemical cell system of FIG. 1;

FIG. 3 is a block diagram of a power converter module for a modular power converter;

FIG. 4 is a block diagram of a half module for the power converter module of FIG. 3; and

FIG. 5 is a block diagram of a modular power converter providing AC to DC and DC to DC conversion.

### DETAILED DESCRIPTION

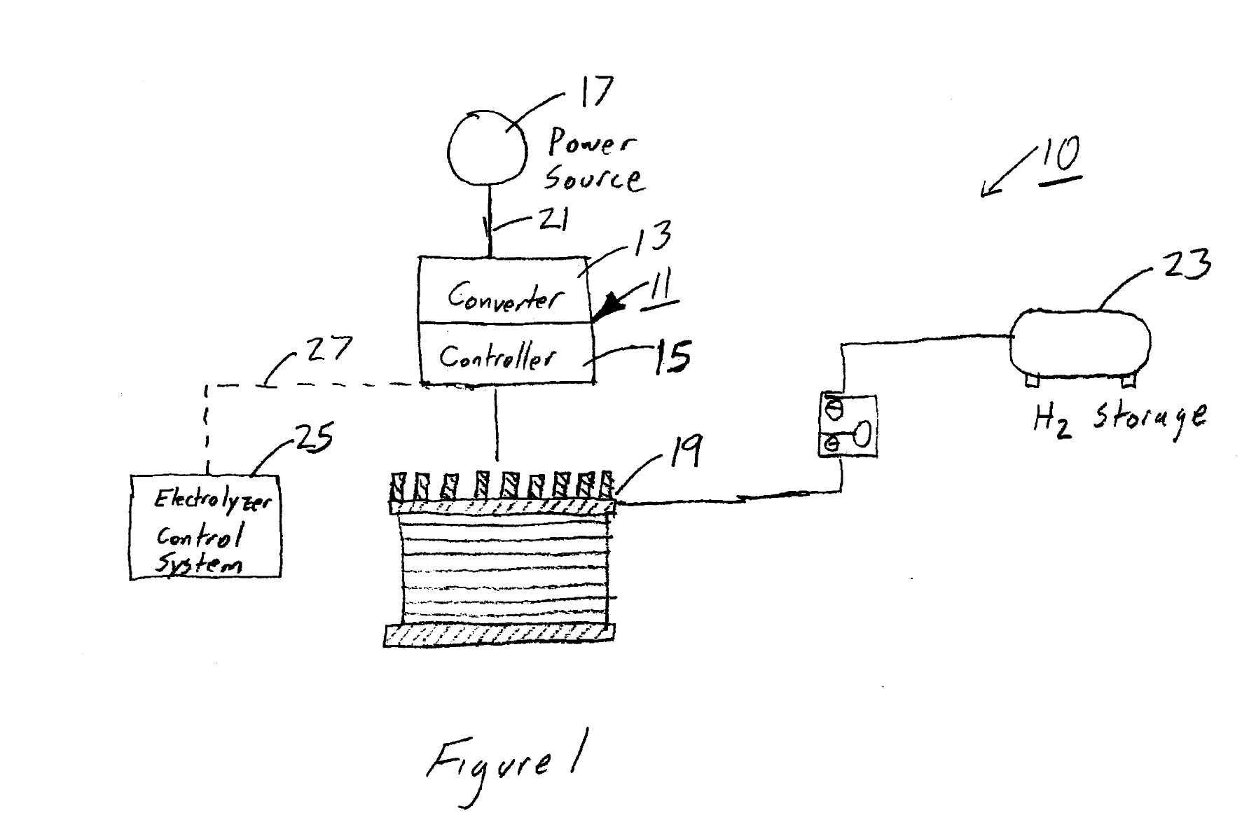

FIG. 1 depicts a block diagram of a power system 10 including a modular power electronics system 11. In the embodiment shown, modular power electronics system 11 includes an alternating current (AC) to direct current (DC) converter 13, which is controlled by a controller 15, to provide power from a primary power source 17, such as generated grid power or that from a renewable source, and an electrolysis cell 19. In the example shown, the primary power source 17 provides power along a primary bus 21; e.g., 3-phase, 240/480 volts alternating current (VAC). It will be appreciated that the actual primary supply voltage may be based upon the type of power source 17 including, but not limited to, other alternating current (AC) voltage sources, direct current (DC) sources, and renewable sources such as wind, solar and the like.

During operation of system 10, the primary power source 17 provides power via power converter 13 to electrolysis cell 19, e.g., an electrolyzer, which generates hydrogen gas. The hydrogen gas generated by the electrolysis cell 19 is stored in an appropriate storage device 23 for later use by, for example, a hydrogen electrochemical device, e.g., a fuel cell, which converts the hydrogen into electricity.

Operation of the electrolysis cell 19 and its ancillary equipment (e.g., pumps, valves, fans, etc.) is controlled by an electrolyzer control system 25. For example, once the amount of hydrogen in the hydrogen storage device 23 decreases below a pre-determined level, the electrolyzer control system 25 engages electrolysis cell 19 and its ancillary equipment to replenish the hydrogen supply. Electrolyzer control system 25 also provides control signals to, and receives control signals from, controller 15 of the modular power electronics system 11 via an input/output (I/O) connection 27.

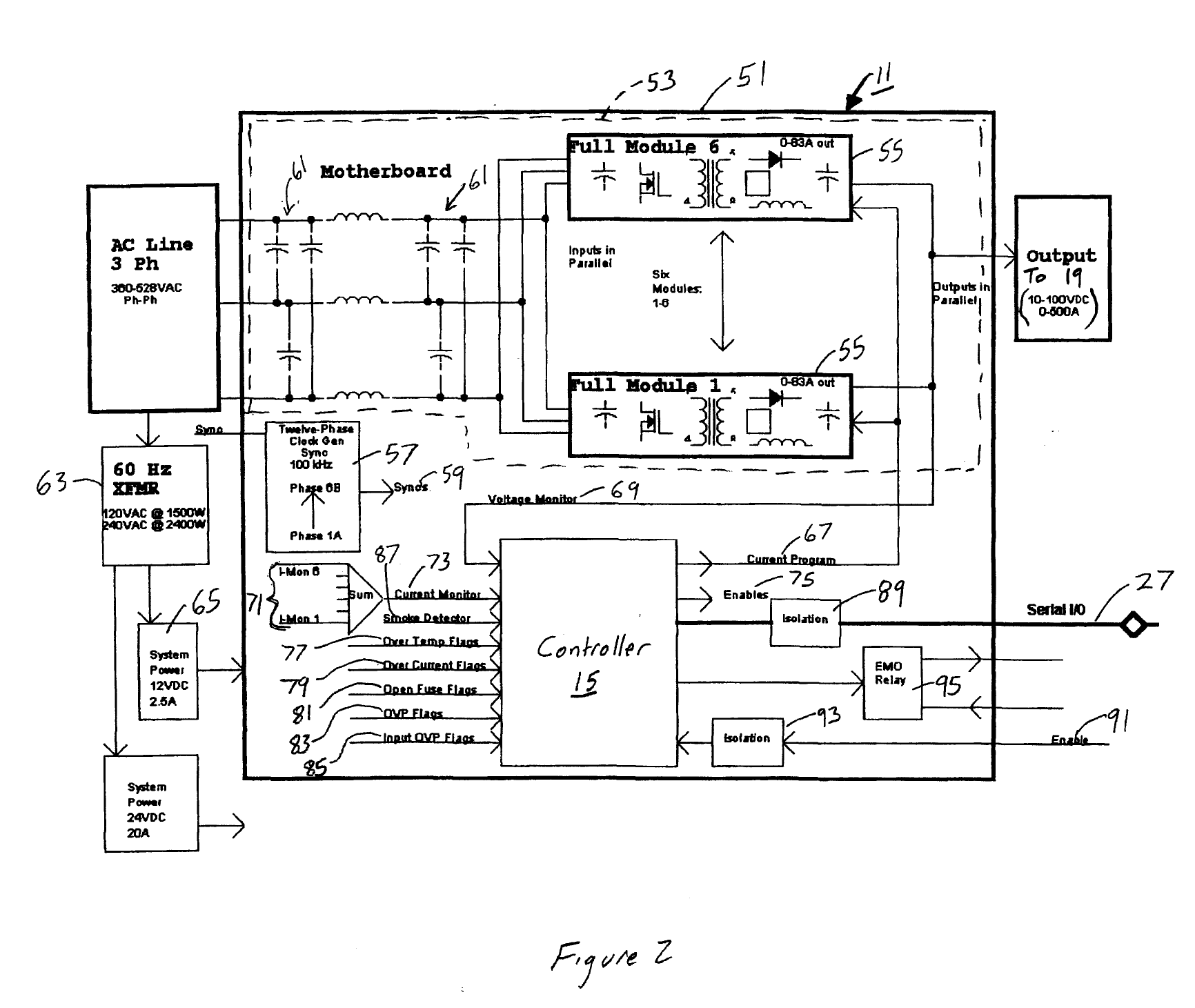

Referring to FIG. 2, a schematic block diagram of an embodiment of the modular power electronics system 11 is shown. Modular power electronics system 11 is housed in a single power converter box 51, which may be rack-mounted. System 11 includes a motherboard 53 having a plurality of power converter modules 55 disposed thereon. Each module is rated for a predetermined power (e.g., 8 kilowatts (kW)), and provides a series/parallel building block for an expandable motherboard. Each converter module 55 is preferably formed on a single circuit board that be coupled to motherboard 53 via a plug-in arrangement, using a card cage for example, so that the converter modules 53 may be easily removed and installed as needed to meet the power requirements of the electrolyzer 19 or as needed for replacement during maintenance. Also connected to motherboard 53 is controller 15 and a system clock 57, each of which may be mounted directly on, or separated from, motherboard 53. System clock 57 provides synchronization signals 59 to the modules 55. Controller 15 may include a microprocessor and associated electronics.

In the embodiment of FIG. 2, motherboard 53 receives 3-phase AC input and filters the AC input using an arrangement of capacitors 61 or the like. The filtered AC is provided in parallel to modules 55. Operating power for the motherboard 53, power converter modules 55, and controller 15 is provided by a transformer 63 and an AC to DC converter 65.

The power converter modules 55 receive a filtered, variable voltage, AC input from the motherboard 53, and provide a programmable DC output in parallel to the electrolyzer 19. For example, each module 55 may provide a programmable current output of less than or equal to about 83 amperes DC (ADC), at a voltage of about 10 volts (v) to about 90 V. Controller 15 controls the DC output for each module 55. Controller 15 senses the voltage at the common DC output of the modules 55 using a voltage monitor line 69, receives signals 71 indicative of output current at each of the modules 55, and provides a current program signal 67 to the modules 55 in response to the voltage at voltage monitor line 69 and a signal 73 indicative of a sum of the current signals 71. In response to the current program signal 67, the modules 55 adjust the DC output to electrolyzer 19.

Controller 15 provides a unique enable signal 75 to each module 55, which enables and disables individual modules 55. Signals provided by the modules 55 to the controller 15 include: overtemperature flags 77 indicating a that a temperature associated with a module 55 has reached a predetermined limit, overcurrent flags 79 indicating a current output associated with a module 55 has reached a predetermined limit, open fuse flags 81 indicating that a fuse associated with a module 55 has opened, overvoltage flags 83 indicating an output voltage associated with a module 55 has reached a predetermined limit, and input overvoltage flags 85 indicating an input voltage associated with a module 55 has reached a predetermined limit. Controller 15 also receives a smoke detector signal 87 from a smoke detector located within the power converter box 51. The smoke detector signal 87 indicates the presence of smoke in the power converter box 51.

Controller 15 is coupled to the electrolyzer control system 25 (see FIG. 1) via isolated input/output (I/O) connection 27. An isolator 89, used to isolate I/O connection 27, may include, for example, an optical isolator. Using I/O connection 27, control signals are provided between the electrolyzer control system 25 and controller 15. Such signals may include, for example, signals indicating the status of the power converter box 51 (e.g., if smoke has been detected, voltage output, and current output), and signals indicating the status of the modules 55 (e.g., the occurrence of overtemperature, overcurrent, open fuse, overvoltage output, and overvoltage input). These signals may be used by the electrolyzer control system 25, for example, to modify the operation of the electrolyzer 19 and its ancillary equipment. Such signals may also include signals used by controller 15 to alter the current program signal 67 and, thus, the DC current output to electrolyzer 19.

Controller 15 may receive an enable signal 91 from the electrolyzer control system 25 via an alternate, isolated connection 93. In response to receiving the enable signal 91, the controller 15 would enable or disable one or more modules 55. Controller 15 may activate a relay 95 to interrupt operating power to the electrolyzer 19 in certain predetermined cases. For example, controller 15 may activate the relay 95 upon detection of smoke in the power converter box 51.

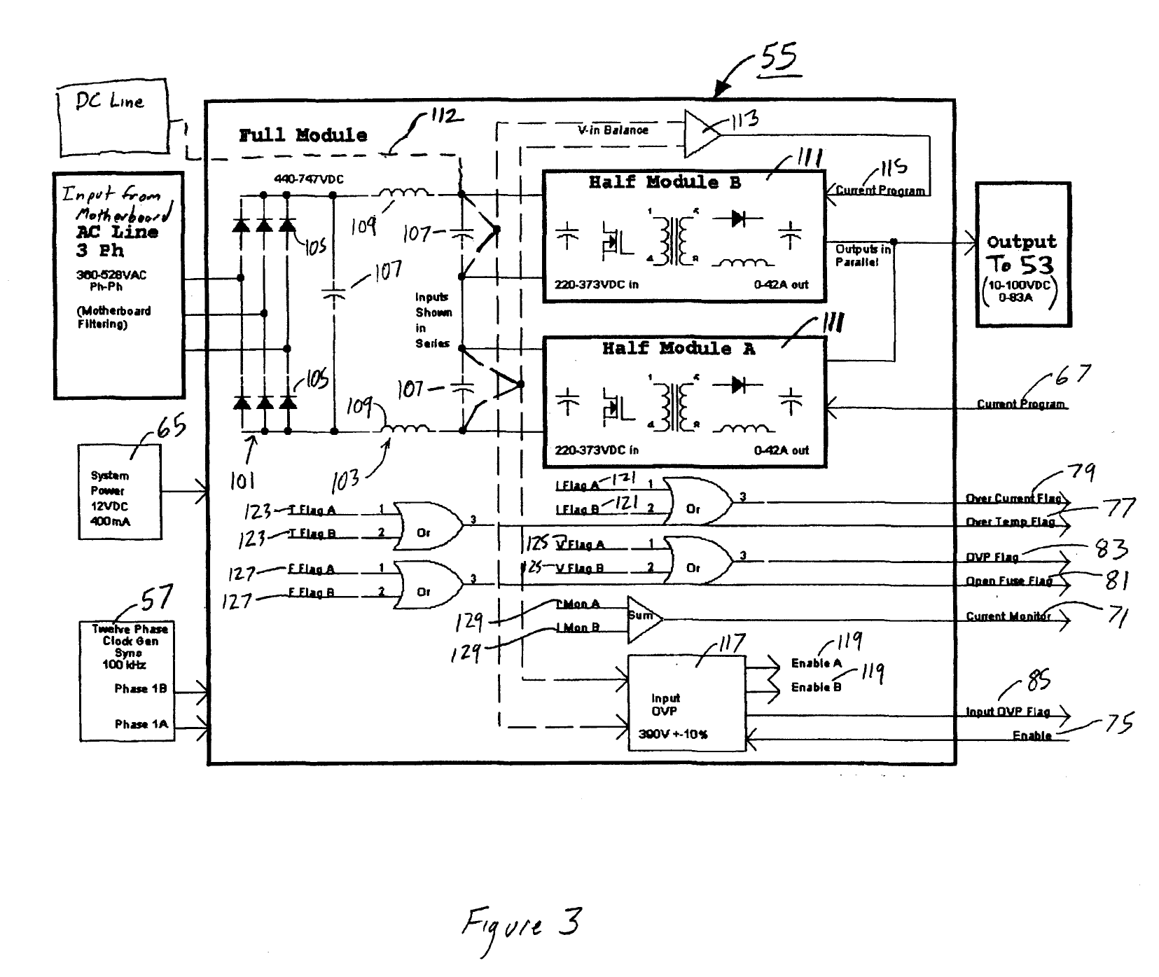

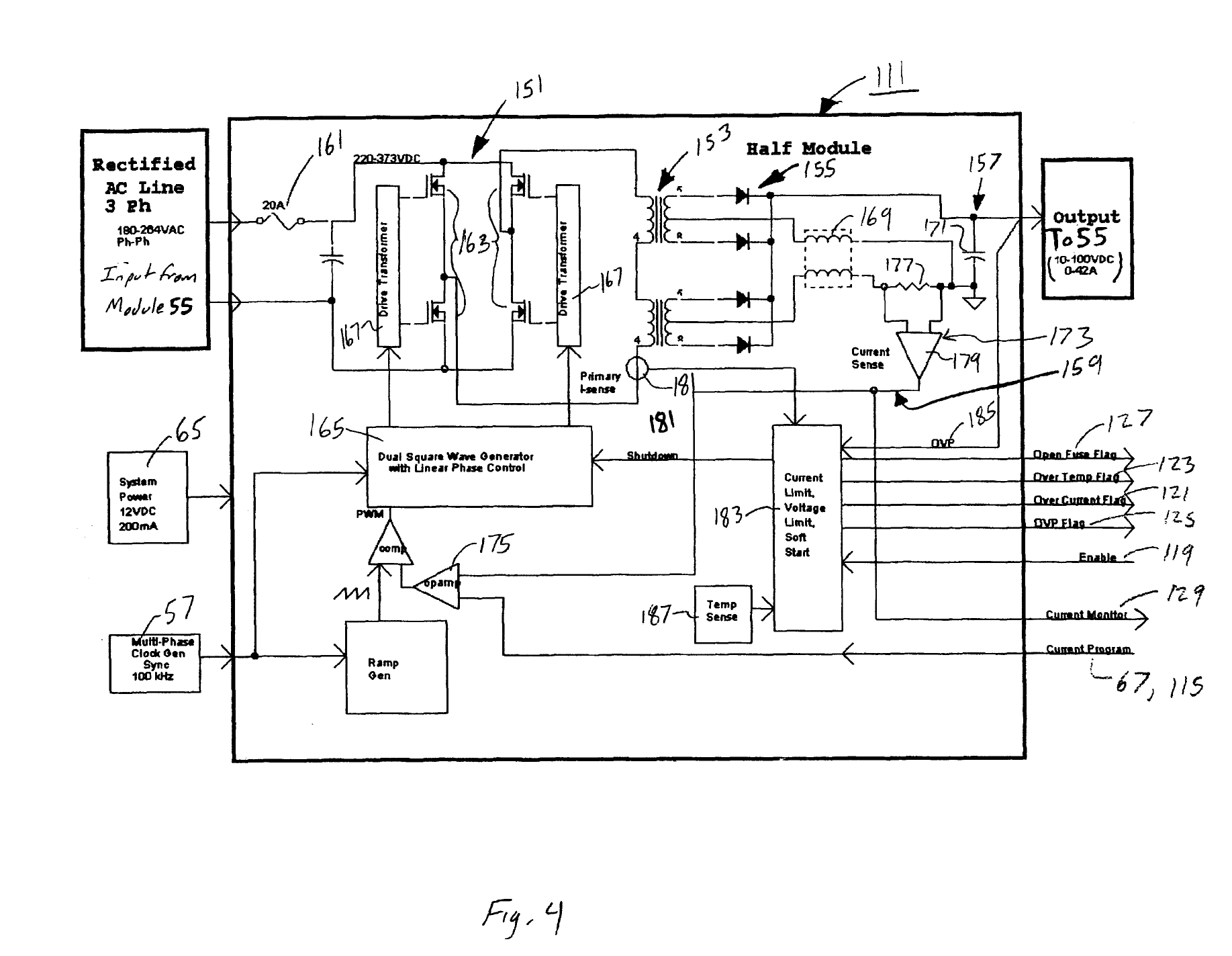

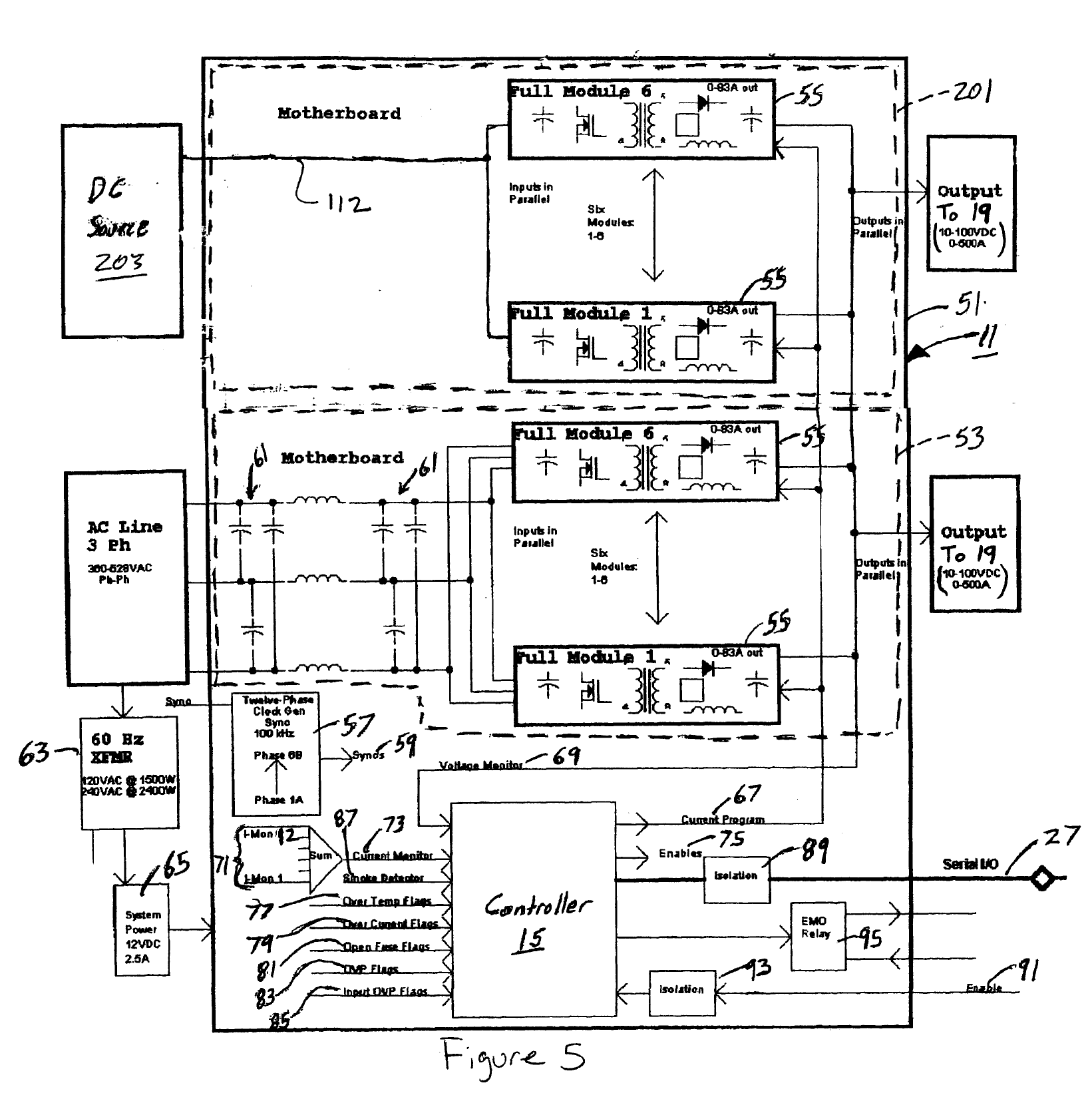

Referring to FIG. 3, a power converter module 55 is shown in further detail. Each power converter module 55 includes input isolation, provided by a rectifier 101 and electromagnetic interference (EMI) filter 103, and a small amount of energy storage on the front end. Within each power converter module 55, the 3-phase AC input power is converted to DC through rectifier 101, which comprises six discrete diodes 105 in a bridge configuration. These diodes 105 may have individual heat sinks and may be cooled by forced air. The rectifier 101 feeds EMI filter 103, which comprises film capacitors 107 and small inductors 109. The EMI filter 103 provides rectified and filtered DC current to a plurality of half modules 111. Each half module 111 includes a phase shift bridge converter, output transformer, rectifiers and filtering, current feedback control, and protection circuits, as will be described hereinafter with reference to FIG. 4. Power converter module 55 includes an optional DC input line 112, which allows the power converter module 55 to be used for either AC to DC conversion or DC to DC conversion, as will be discussed hereinafter with reference to FIGS. 5 and 6.

In the embodiment shown in FIG. 3, the rectified and filtered DC current is provided in series to the plurality of half modules 111. A jumper node (not shown) may be provided on each module 55 to allow selection between parallel and series input to the half modules 111 and, thereby, can be used to select an operating voltage for the module 55 (e.g., select between 240 and 480 VAC operation). The DC output of each half module 111 is arranged in parallel, and is provided to motherboard 53.

When operated in parallel (e.g., 240 VAC), the two half modules 111 receive the same current program signal 67, and they both then put out the same current. In series (e.g., 480 VAC), however, active balancing must be done to keep the voltage to each of the two half modules 111 equal. For series operation, input voltage is balanced between the half modules 111 by sensing voltage across capacitors 107, and proving the sensed voltages to a device 113. Active balancing is achieved by providing the current program signal 67 to one of the half modules 111. The half module 111 produces output, but this draws down its input voltage, increasing the voltage across the other half module 111 input. Device 113 senses this imbalance and provides a current program signal 115 to the top converter to command current output. This continues until the input voltages are balanced.

The voltage sensed across capacitors 107 is also used as an input to overvoltage detection circuitry 117. Overvoltage detection circuitry 117 compares the voltage input to each half module 111 with a predetermined threshold value. If the voltage input exceeds the threshold, the overvoltage detection circuitry 117 disables one or more half module 111 using enable signals 119. The overvoltage detection circuitry 117 also provides the input overvoltage flag 85 to controller 15, and receives the enable signal 75 for the module 55. In response to receiving the enable signal 75, the overvoltage detection circuitry 117 provides enable signals 119 to the half modules 111 to enable or disable the half modules 111.

Each half module 111 provides various output signals that are used to generate various flags provided to controller 15. Each half module 111 provides a current flag signal 121 indicating that current output from the half module 111 has exceeded some predetermined threshold. If either half module 111 outputs a current flag signal 121, the overcurrent flag 79 is provided to controller 15. Each half module 111 provides a temperature flag 123 indicating that a temperature associated with the half module 111 has exceeded a predetermined threshold. If either half module 111 outputs a temperature flag 123, the over temperature flag 77 is provided to controller 15. Each half module 111 also provides an output voltage flag 125 and a fuse flag 127. The output voltage flag 125 is provided in response to the output voltage from a half module 111 exceeding a predetermined threshold, and fuse flag 127 is provided in response to opening of a fuse associated with a half module. If an output voltage flag 125 or a fuse flag 127 is output by either half module 111, the overvoltage flag 83 or the open fuse flag 81, respectively, is provided to controller 15. Finally, each half module 111 outputs a current signal 129 indicative of output current at each of the half modules 111. The sum of the current signals 129 is output as current signal 71.

Referring to FIG. 4, a half module 111 is shown in further detail. Each half module 111 includes a chopping circuit 151 to chop the DC input from the module 55 and provide an AC output to transformers 153. Transformers 153 step the AC either up or down, rectifiers 155 convert the AC to DC, and filter 157 smoothes the resulting DC current. Each half module 111 further includes current feedback control path 159, and fuse protection 161.

In the embodiment shown, chopping circuit 151 comprises a full bridge converter. A full bridge converter is used to for several reasons. Among these are high utilization of the transformer core, good use of semiconductors, and recycling of leakage energy. In this embodiment, a phase shift type of operation is used. This results in soft switching most of the time. Soft switching (or quasiresonant) is when the field effect transistors (FETs) 163 turn on or off into zero voltage, with the voltage transitions following the resonant curve of the transformer and switching capacitors. Low EMI and low losses result.

Operation of the full bridge converter is achieved by the phase control between the two sets of FETs 163. Each set of FETs 163 is a series combination, alternatively referred to as a “totem pole”. These are switched alternately on and off with a full square-wave (no pulse width modulation) drive transformer 167 having an input provided by a dual square wave generator 165. The phasing of each drive transformer 167 ensures that there is no cross conduction. Drive enhancement networks may be used to mitigate the effects of leakage in the drive transformers 167.

For example, where the two totem poles both have 100% modulation square-wave drives, the power transformer 153 is connected across the halfway points of the totem poles formed by FETs 163. When the top and bottom FETs 163 of both totem poles are switched in phase, there is no voltage across the primary winding of transformer 153 and, therefore, no output to the module 55. When the totem poles are switched completely out of phase, full voltage is applied to the primary winding of transformer 153.

The dual square wave generator 165 provides linear control of the phase across the range for full output regulation. The order of switching is such that when a FET 163 turns off, the conduction current commutates the voltage to the opposing FET 163 in the totem pole. Its internal diode then conducts until the FET 163 is turned on. In this manner, very low switching losses are achieved.

Two transformers 153 are used per full bridge section of FETs 163. These transformers 153 are connected in series on the input and parallel on the output. Parallel output is used so that more low current rectifiers may be used on the output to increase the current rating. Series input is used to provide current sharing between the output rectifiers 155. For this reason, current output should be sensed in one leg only.

The output rectifiers 155 are connected in half-wave center-tap configuration. This gives only one junction drop at a time for higher efficiency. One main inductor 169 is used for both sets of rectifiers 155 to use a common core size with the transformers 153. A single film capacitor 171 is used for output voltage filtering. The film capacitor 171 provides a fixed impedance for loop gain calculations, and provides a T filter between the inductor 169 and the inductance of the wiring to the electrolyzer 19 (see FIG. 1). Further ripple reduction may be achieved by running the two half modules 111 out of phase (a fixed offset on main clock 57 (see FIG. 5), not to be confused with the phase control regulation).

Since the output of module 55 is a controlled current, the current feedback control path 159 includes a current sensor 173 (as opposed to voltage sensing), with comparison to the current program signal 67 or 115. The current sensor 173 includes a low value sense resistor 177 in the output line. The voltage developed across the resistor 177 is amplified by amplifier 179 up to the same level as the current program signal 67 or 115. The amplified signal is fed to an opamp 175 to generate an error voltage, which controls the dual square wave generator 165. The amplified signal is also provided as current monitor signal 129 to module 55. Average current mode control is used, resulting in a circuit having a high bandwidth. A couple of op-amps may be used to condition the current program signal 67 or 115, a precision clamp may be used to set the maximum current, and a buffer may be used to stiffen the current program signal 67 or 115 after the clamp.

For fault protection, and possibly transients, current limits are established by a control processor 183. A current transformer 181 senses the FET 163 bridge current to the transformers 153 and provides a signal indicative of this current to control processor 183. If the signal indicates that the current has reached a first limit, control processor 183 cuts back the phasing, and if the signal indicates that the current has reached a second limit, control processor 183 resets chopping circuit 151 and initiates a soft start. Control processor 183 may also generate current flag signal 121 in response to the sensed current reaching either of these limits.

Control processor 183 also implements an over-voltage protection limit by sensing output voltage 185. If the output voltage 185 exceeds a predetermined limit, control processor 183 may generate an output voltage flag 125. A temperature sensor 187 provides a signal indicative of a temperature associated with the half module 111 to control processor 183. If this temperature exceeds a predetermined limit, control processor 183 provides temperature flag 121 as output. Control processor 183 also outputs fuse flag 127 if fuse 161 is opened. Enable signals 119 are received by control processor 183, and starts or shuts down dual square wave generator 165 in response to the enable signal 119.

The modular power electronics system 11 allows a single motherboard 53 to be customized as needed to meet the requirements of the power system 10. For example, motherboard 53 may be fitted with one or two modules 55 for low power electrolyzers 19, while the motherboard 53 may be fitted with many (e.g., thirty (30) or more) modules 55 for relatively high powered electrolyzers 19. By using common (interchangeable) parts, the modular power electronics system 11 takes advantage of volume manufacturing and commonality of parts across a product platform. Also, due to the fact that the modular power electronics system 11 employs circuit board components, it takes advantage of circuit board manufacturing techniques such as pick and place, wave soldering, and surface mount technologies. These technologies help to reduce the price of the modular power electronics system 11, while providing high efficiency. Indeed, with the modular power electronics system 11, efficiencies greater than 90% may be achievable.

FIG. 5 depicts an alternative embodiment of the modular power electronics system 11. In this embodiment, an additional motherboard 201 is added to power converter box 51 for providing DC to DC conversion. Motherboard 201 includes a DC input from a DC power source 203. DC power source 203 may include, for example, an electrochemical cell (e.g., a fuel cell), a capacitor, a battery, a solar collector, or any other DC power source. The DC input is connected in parallel to a plurality of power converter modules 55, which are mounted to motherboard 201 in a similar manner as that described with reference to motherboard 53. As shown in FIG. 3, the DC input line 112 may be used for providing the DC input to each module 55 on motherboard 201. The DC output of motherboard 201 is provided to, for example, electrolysis cell 19. Control of modules 55 on each motherboard 53 and 201 is provided by controller 15. It will be appreciated that the number of motherboards added to the system 11 is limited only by the size of the converter box 51 and processing limitations of controller 15. Thus, the modular power electronics system 11 is highly flexible, providing the ability to add many different converters to a single rack mountable converter box 51. Alternatively, a single motherboard could be configured to include the circuitry shown on motherboard 53 and motherboard 201, thus allowing a single motherboard to provide both AC to DC and DC to DC conversion.

The use of a single controller 15 for all of the converters provides tightly integrated control of the power system 10. This is especially advantageous for regenerative fuel cell systems, which require power output integration of primary and secondary power sources. The use of a common controller 15 also reduces the cost of the system 11 by eliminating redundant processors. The cost of the system 11 is further reduced by the use of a standard, interchangeable module 55 in both converters and by providing motherboard designs that can be customized by simply adding or removing modules 55. As previously discussed, by using common parts, the modular power electronics system 11 takes advantage of volume manufacturing and commonality of parts across a product platform.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention.

1. Power electronics for an electrochemical cell system, the power electronics comprising:
a first power converter including:
a plurality of interchangeable power converter modules, and
a first motherboard configured to receive the plurality of interchangeable power converter modules;
wherein a power rating of the first power converter is capable of being changed by adjusting a number of the interchangeable power converter modules attached to the first motherboard.

2. The power electronics of claim 1, further comprising:
a controller configured to adjust a current output from the interchangeable power converter modules attached to the first motherboard.

3. The power electronics of claim 2, further comprising:
a second power converter including:
a second motherboard configured to receive at least a portion of the plurality of interchangeable power converter modules;
wherein a power rating of the second power converter is capable of being adjusted by changing a number of the interchangeable power converter modules attached to the second motherboard.

4. The power electronics of claim 3, wherein the controller is further configured to adjust a current output from the interchangeable power converter modules attached to the second motherboard.

5. The power electronics of claim 4, wherein the first power converter is one of an AC-to-DC converter and a DC-to-DC converter, and the second power converter is one of an AC-to-DC converter and a DC-to-DC converter.

6. The power electronics of claim 2, wherein each power converter module in the plurality of power converter modules includes:
a first chopping circuit configured to receive a first DC input and provide a first AC output;
a first transformer configured to adjust a power of the first AC output and provide a first transformed AC output; and
a first rectifier configured to receive the first transformed AC output and provide a first DC output.

7. The power electronics of claim 6, wherein the each power converter module in the plurality of power converter modules includes:
a first half-module including the first chopping circuit, the first transformer, and the first rectifier; and
a second half-module including:
a second chopping circuit configured to receive a second DC input and provide a second AC output;
a second transformer configured to adjust a power of the second AC output and provide a second transformed AC output; and
a second rectifier configured to receive the second transformed AC output and provide a second DC output.

8. The power electronics of claim 7, wherein the first DC output from the first half-module and the second DC output from the second half-module are controlled by the controller.

9. The power electronics of claim 4, wherein the first motherboard, the second motherboard, and the controller are mounted in a common power converter box.

10. The power electronics of claim 2, wherein the controller is configured to receive signals from the interchangeable power converter modules attached to the first motherboard, the signals indicating at least one of:
an output current, a temperature, a fuse status, an output voltage, an input voltage, and combinations including two or more of the foregoing.

11. An electrochemical cell system, comprising:
a first power source;
an electrochemical cell; and
a modular power electronics system electrically connected between the first power source and the electrochemical cell, the modular power electronics system including:
a first power converter adapted for conditioning electrical current flow between the first power source and the electrochemical cell, the first power converter including:
a plurality of interchangeable power converter modules, and
a first motherboard configured to receive the plurality of interchangeable power converter modules;
wherein a power rating of the first power converter is capable of being adjusted by changing a number of the interchangeable power converter modules attached to the first motherboard.

12. The electrochemical cell system of claim 11, wherein the modular power electronics system further includes:
a controller configured to adjust a current output from the interchangeable power converter modules attached to the first motherboard.

13. The electrochemical cell system of claim 12, further comprising:
a second power source, wherein the modular power electronics system is electrically connected between the second power source and the electrochemical cell; and
wherein the modular power electronics system further includes:
a second power converter adapted for conditioning electrical current flow between the second power source and the electrochemical cell, the second power converter including:
a second motherboard configured to receive at least a portion of the plurality of interchangeable power converter modules;
wherein a power rating of the second power converter is capable of being adjusted by changing a number of the interchangeable power converter modules attached to the second motherboard.

14. The electrochemical cell system of claim 13, wherein the controller is further configured to adjust a current output from the interchangeable power converter modules attached to the second motherboard.

15. The electrochemical cell system of claim 14, wherein the first power converter is one of an AC-to-DC converter and a DC-to-DC converter, and the second power converter is one of an AC-to-DC converter and a DC-to-DC converter.

16. The electrochemical cell system of claim 12, wherein each power converter module in the plurality of power converter modules includes:
a first chopping circuit configured to receive a first DC input and provide a first AC output;
a first transformer configured to adjust a power of the first AC output and provide a first transformed AC output; and
a first rectifier configured to receive the first transformed AC output and provide a first DC output.

17. The electrochemical cell system of claim 16, wherein the each power converter module in the plurality of power converter modules includes:
a first half-module including the first chopping circuit, the first transformer, and the first rectifier; and
a second half-module including:
a second chopping circuit configured to receive a second DC input and provide a second AC output;
a second transformer configured to adjust a power of the second AC output and provide a second transformed AC output; and
a second rectifier configured to receive the second transformed AC output and provide a second DC output.

18. The electrochemical cell system of claim 17, wherein the first DC output from the first half-module and the second DC output from the second half-module are controlled by the controller.

19. The electrochemical cell system of claim 14, wherein the first motherboard, the second motherboard, and the controller are mounted in a common power converter box.

20. The electrochemical cell system of claim 12, wherein the controller is configured to receive signals from the interchangeable power converter modules attached to the first motherboard, the signals indicating at least one of: an output current, a temperature, a fuse status, an output voltage, an input voltage, and combinations including two or more of the foregoing.

21. The electrochemical cell system of claim 12, wherein the controller is in operable communication with a controller for the electrochemical cell.

22. A method of configuring power electronics for an electrochemical cell system, the power electronics including a first power converter, the method comprising:
configuring the first power converter such that its power rating is adjustable by changing a number of interchangeable power converter modules attached to a first motherboard of the first power converter.

23. The method of claim 22, further comprising:
configuring a plurality of the interchangeable power converter modules attached to the first motherboard such that an associated current output is adjustable using a single controller.

24. The method of claim 23, wherein the power electronics are housed within a power converter box and include a second power converter, the method further comprising:
configuring the power converter box housing the first motherboard and the single controller such that a second motherboard may be included therein; and
configuring the second power converter such that its power rating is adjustable by changing a number of the interchangeable power converter modules attached to the second motherboard.

25. The method of claim 24, further comprising:
configuring a plurality of the interchangeable power converter modules attached to the second motherboard such that an associated current output is adjustable using the single controller.

26. The method of claim 24, wherein the first power converter is one of an AC-to-DC converter and a DC-to-DC converter, and the second power converter is one of an AC-to-DC converter and a DC-to-DC converter.

27. The method of claim 23, further comprising:
configuring the interchangeable power converter modules attached to the first motherboard to provide signals to the controller, the signals indicating at least one of:
an output current, a temperature, a fuse status, an output voltage, an input voltage, and combinations including two or more of the foregoing.

28. The power electronics of claim 2, further comprising:
a second power converter including:
at least a portion of the plurality of interchangeable power converter modules attached to the first motherboard, wherein a power rating of the second power converter is capable of being adjusted by changing a number of the interchangeable power converter modules attached to the first motherboard.

29. The electrochemical cell system of claim 12, further comprising:
a second power source, wherein the modular power electronics system is electrically connected between the second power source and the electrochemical cell; and
wherein the modular power electronics system further includes:
a second power converter adapted for conditioning electrical current flow between the second power source and the electrochemical cell, the second power converter including:
at least a portion of the plurality of interchangeable power converter modules attached to the first motherboard, wherein a power rating of the second power converter is capable of being adjusted by changing a number of the interchangeable power converter modules attached to the first motherboard.

30. The method of claim 22, wherein the power electronics include a second power converter, the method further comprising:
configuring the second power converter such that its power rating is adjustable by changing a number of the interchangeable power converter modules attached to the first motherboard.
